(19) United States
(12) Patent Application Publication
(10) Pub. No.: US 2006/0061264 A1
(43) Pub. Date: Mar. 23, 2006

(54) Electroluminescent device

(76) Inventors: Richard P. Wood, Waterford (CA); Peter G. Hofstra, Guelphe (CA); Alexey N. Krasnov, Mississauga (CA)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/513,636

(22) PCT Filed: Apr. 14, 2003
(86) PCT No.: PCT/CA03/00554

§ 371 Date: Jul. 1, 2005

Related U.S. Application Data
(60) Provisional application No. 60/377,639, filed on May 6, 2002.

(51) Int. Cl. H01J 1/62; H01J 63/04

(52) U.S. Cl. 313/504

(57) ABSTRACT

An aspect of the invention provides an electroluminescent device that incorporates a partially-absorbing layer which is disposed in front of an emitting electroluminescent layer and reflective rear electrode. The thickness and material of the partially-absorbing layer cooperates with the thickness of the electroluminescent layer to cause at least some reduction in ambient incident of the display.

### PRIORITY CLAIM

The present application claims priority from U.S. Provisional Patent Application, filed on May 6, 2002, and bearing Ser. No. 60/377,639, the contents of which are incorporated herein by reference.

### FIELD OF THE INVENTION

The present invention relates generally to flat panel display technology, and more particularly relates to thin film electroluminescent devices (TFEL) having contrast enhancement features.

### BACKGROUND OF THE INVENTION

Electroluminescent devices (EL) are well known. Inorganic TFEL devices have been manufactured on a commercial scale by companies such as Luxell Technologies Inc. of 2145 Meadowpine Blvd., Mississauga, Ontario, Canada and Planar. Organic TFEL Planar Systems, Inc of 1400 NW Compton Dr Beaverton, Oreg., USA. A detailed description of a prior art TFEL device is described in U.S. Pat. No. 5,049,780 to Dobrowolski (“Dobrowolski”), the contents of which are incorporated herein by reference.

Organic TFEL devices (also known as Organic Light Emitting Devices or OLEDs) are just now being manufactured on a commercial scale, and are expected to take a significant market share of the commercially produced flat panel display market. A prior art OLED device is described in WO0108240 to Hofstra (“Hofstra #1”) and CA2,352,390 to Hofstra (“Hofstra #2”), both of which are incorporated herein by reference.

One problem common to both Inorganic and Organic TFEL devices is high-reflectivity of ambient light from the rear electrode when reflective materials such as Aluminum are used. Dobrowolski, Hofstra #1 and Hofstra #2 each teach various ways to reduce ambient light reflectivity using optical interference.

One problem common to certain implementations of certain embodiments taught in Dobrowolski, Hofstra #1 and Hofstra #2, wherein the optical interference member is placed in front of the reflective rear electrode, is that a certain portion of backwardly emitted light from the emitting layer is also reduced by the optical interference effect of the optical interference member. In devices configured without the aforementioned embodiments, this backwardly emitted light could otherwise be used to actually enhance the overall light emitted by the emitting layer, particularly where the thickness of the emitting layer and its associated transport layers are tuned to produce constructive optical interference from the reflected backwardly emitted light.

### SUMMARY OF THE INVENTION

It is therefore an object of the present invention to provide a novel electroluminescent device that obviates or mitigates at least one of the above identified disadvantages of the prior art. A first aspect of the invention provides an electroluminescent device comprising a transparent substrate for facing a viewer in front of the substrate and a transparent electrode disposed behind the substrate on a side of the substrate opposite from the viewer. The device also includes a partially-absorbing layer disposed behind the electrode and an electroluminescent emitting layer disposed behind the partially-absorbing layer. The device also includes a reflective rear electrode disposed behind the emitting layer, the emitting layer being made from a material operable to emit light towards when a potential is applied between the electrodes. The partially-absorbing layer and the emitting layer each being made from a material and having a thickness that are chosen to cooperate with the reflective rear electrode such that at least a portion of ambient light incident on the device is reduced.

In a particular implementation of the first aspect, the emitting layer thickness is also chosen such that, in cooperation with backwardly reflections of emitted light off of the rear electrode, at least a portion of emitted light is increased due to constructive optical interference.

The partially-absorbing material can be made from a metal oxide selected from the group consisting of AlO, SiO, InO, SnO, ZnO.

The partially-absorbing material can also be made from a metal:metal oxide materials selected from the group consisting of Cr:SiO, Al:SiO, In:SnO or Al:ZnO.

A second aspect of the invention provides an electroluminescent device comprising a transparent substrate for facing a viewer in front of the substrate and a transparent anode disposed behind the substrate on a side of the substrate opposite from the viewer. The device also includes a hole blocking layer disposed behind the transparent electrode; a hole transport layer disposed behind the hole blocking layer; a partially-absorbing layer disposed behind the hole blocking layer and an organic electroluminescent emitting layer disposed behind the partially-absorbing layer. The device also includes a reflective rear cathode disposed behind the emitting layer, the emitting layer being made from a material operable to emit light towards when a current is applied between the electrodes. The partially-absorbing layer and the emitting layer each being made from a material and having a thickness that are chosen to cooperate with the reflective rear cathode such that at least a portion of ambient light incident on the device is reduced.

In a particular implementation of the second aspect, the anode is made from ITO, the hole transport layer is made from TPD and the hole blocking layer is made from CuPC. The cathode is made from Aluminum, and the electroluminescent layer is made from Alq3. The electron transport layer can also be made from Alq3, and the partially absorbing layer is made from AlSiO. The the substrate can be made from either a rigid or flexible material.

A third aspect of the invention provides an electroluminescent device comprising a transparent substrate for facing a viewer in front of the substrate and a transparent anode made from ITO and having a thickness of between about 800 Å and about 3000 Å, the anode being disposed behind the substrate on a side of the substrate opposite from the viewer. The device also includes a hole blocking layer made from CuPC and having a thickness of less than about 1000 Å, the hole blocking layer being disposed behind the transparent electrode. The device also includes a hole transport layer made from TPD and having a thickness of less than about 1000 Å, the hole transport layer being disposed behind the hole blocking layer. The device also includes a partially-absorbing layer made from AlSiO and having a thickness of between about 800 Å and about 3000 Å, the partially-absorbing layer being disposed behind the hole blocking layer. The device also includes an organic electroluminescent emitting layer made from Alq3 and having a thickness of between about 300 Å and about 1000 Å, the electroluminescent emitting layer disposed behind the partially-absorbing layer. The device also includes a reflective rear cathode made from Al and having a thickness of between about 800 Å and about 4000 Å, the cathode disposed behind the emitting layer, the Alq3 operable to emit light towards when a current is applied between the anode and the cathode and wherein a specific thickness of each of the partially-absorbing layer and the emitting layer are chosen to cooperate with the reflective rear cathode to reduce at least a portion of ambient light incident on the device.

In a particular implementation of the third aspect, the ITO layer has a thickness of from about between about 800 Å and about 1600 Å, the CUPC layer has a thickness of between about 100 Å and about 500 Å, the TPD layer has a thickness of between about 100 Å and about 500 Å, and the AlSiO layer has a thickness of between about 200 Å and about 1400 Å. The Alq3 layer has a thickness of between 400 Å and about 800 Å. and the rear cathode has a thickness of between about 900 Å and about 1400 Å.

In a particular implementation of the third aspect, there is further provided an electron transport layer made from Alq3 between the rear cathode and the emitting layer and having a thickness of less than about 800 Å.

### BRIEF DESCRIPTION OF THE DRAWINGS

Preferred embodiments of the present invention will now be discussed, by way of example only, with reference to the attached Figures in which:

FIG. 1 is a side-view of a schematic representation of an EL device in accordance with an embodiment of the invention;

FIG. 2 is the device shown in FIG. 1 depicted with ambient light incident thereon;

FIG. 3 is the device shown in FIG. 2 depicted with certain effects of reflection reduction of the ambient light;

FIG. 4 is the device shown in FIG. 3 depicted with light emission;

FIG. 5 is a side-view of a schematic representation of an EL device in accordance with another embodiment of the invention; and,

FIG. 6 is a side-view of a schematic representation of an EL device in accordance with another embodiment of the invention.

### DETAILED DESCRIPTION OF THE INVENTION

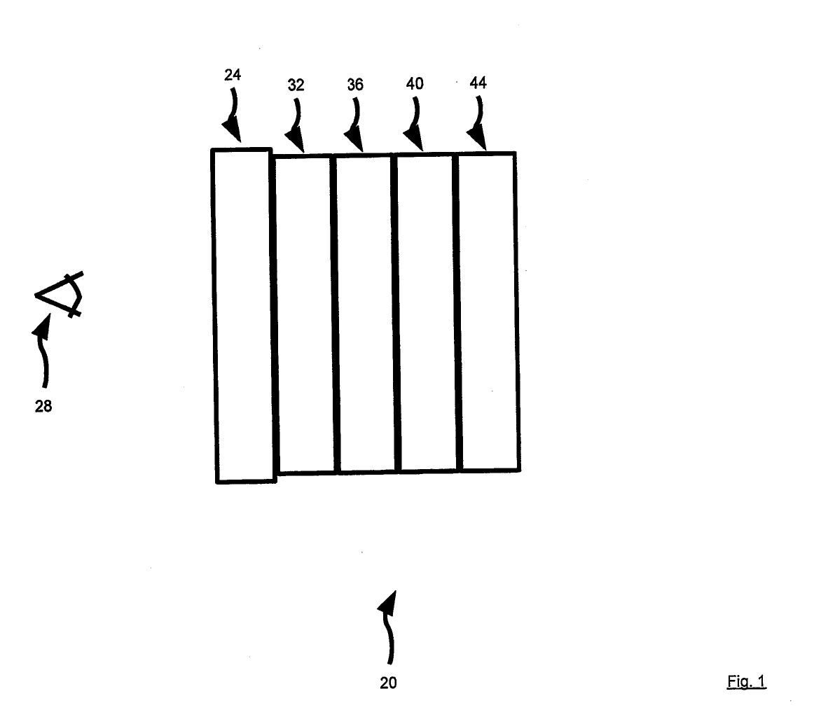

Referring now to FIG. 1, an EL device in accordance with an embodiment of the invention is indicated generally at 20. Device 20 includes a transparent substrate 24 which faces a viewer 28 in front of device 20. Behind substrate 24 is a transparent electrode 32, followed by a partially-absorbing layer 36, an emitting layer 40 and a reflective rear electrode 44.

Substrate 24 is typically glass, but any other suitable transparent substrate can be used, as desired, including flexible substrates. Similarly, transparent electrode 32 is typically made from Indium Tin Oxide (“ITO”), but any other transparent electrode material can be used, as desired.

Partially-absorbing layer 36 is typically made from partially-absorbing materials. Partially-absorbing materials used in the present invention can include metal oxides, such as AlO, SiO, InO, SnO, ZnO. (In the case of the foregoing metal oxides, it will be understood by those of skill in the art that a metal rich oxide is used to achieve partially-absorbency.) It is also believed that metal:metal oxide materials can be suitable for the present invention, such as Cr:SiO, Al:SiO, In:SnO or Al:ZnO. Regardless of the type of partially-absorbing materials chosen for layer 36, it is presently preferred that the materials and thickness for layer 36 be chosen so that it is partially reflective, partially-absorbing, and partially-transmissive of ambient light incident thereon. As will be discussed in greater detail below, these characteristics of layer 36 are chosen to cooperate with the amount and phase of light passing through emitting layer 40 and reflected off rear electrode 44.

Emitting layer 40 can be either made from an inorganic emitting material such as ZnS:Mn, or an organic emitting material such as Alq3 or PPV. The thickness of emitting layer 40 is selected so that a desired amount of light is emitted from layer 40, and so that the overall device 20 has other suitable optical-electrical properties. In particular, the thickness of layer 40 is chosen to cooperate with layers 36 and layer 44 to cause at least some phase-shifting of ambient light A entering layer 40, and thereby create a destructive optical interference effect with the portion of ambient light A that is reflected off of partially absorbing layer 36. The thickness of layer 40 is also chosen to achieve a certain amount of phase shifting of backwardly emitted light that is reflected of rear electrode 44, to thereby achieve at least some constructive interference of emitted light and thereby enhance the emission of light from device 20.

Depending on which type of emitting material is used, device 20 will typically include additional layers appropriate to the desired design and operation of the device. For example, dielectric layers may be added (in the case of inorganic emitters) or transport layers may be added (in the case of organic emitters). Such additional layers can also have thicknesses that are selected in conjunction with other thicknesses of layers in device 20 to achieve the desired optical effects. Further details on possibilities for such additional layers will be discussed in greater detail below.

Reflective rear electrode 44 is typically made from Aluminum or any other suitable conducting material that complements the desired electrical operation of emitting layer 40 and optical characteristics of device 20.

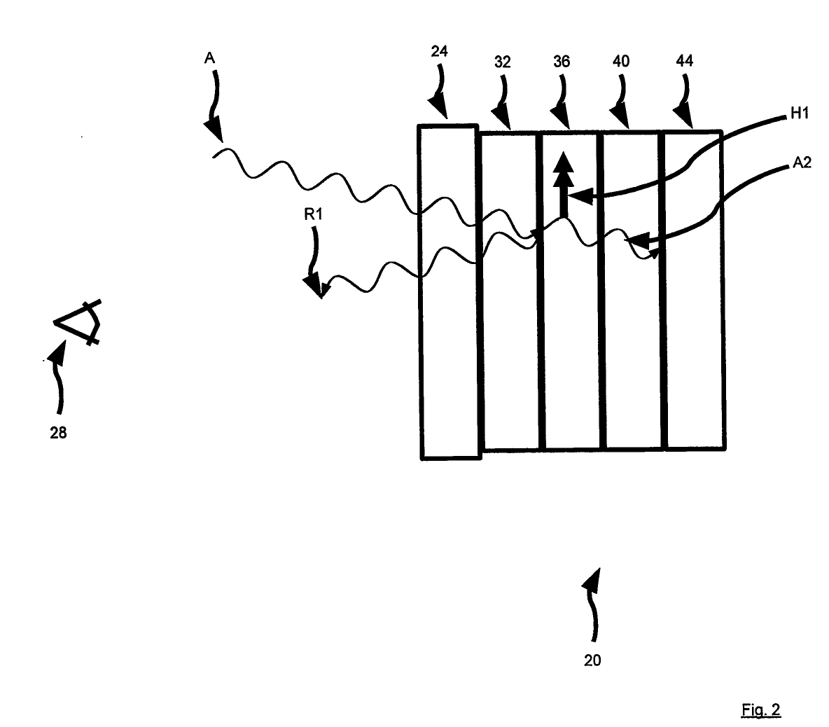

Referring now to FIG. 2, in operation, ambient light incident upon display 20 is indicated at reference character A. A majority of ambient light A passes through substrate 24 and transparent electrode 32 (with some negligible amounts of reflections which shall be ignored for the purposes of this explanation). Ambient light A then strikes the surface of partially-absorbing layer 36, at which point a first portion of ambient light A is reflected as reflection R1. The remainder of ambient light A that is not reflected as reflection R1 continues into partially-absorbing layer 36, at which point a second portion of ambient light A is absorbed as into layer 36, typically as heat, as represented by heat vector H1. The remainder of ambient light then continues into emitting layer 40, as indicated at reference character A2.

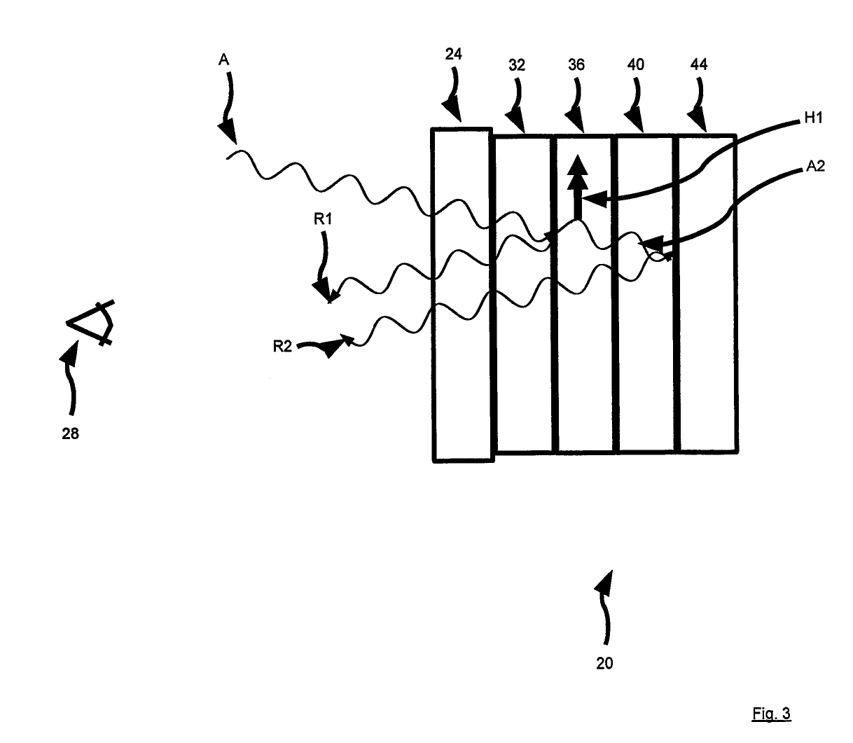

Referring now to FIG. 3, next the ambient light A2 that is incident on rear electrode 44 is reflected thereoff, as represented on FIG. 3 by reflection R2. Further, due to the chosen thickness of layer 40, reflection R2 is reflected about one-hundred-and-eighty-degrees out of phase from ambient light A2, and also about one-hundred-and-eighty-degrees out of phase from reflection R1. Reflection R1 thus travels back through layer 40 and layer 36, at which point it exits the surface of layer 36. Accordingly, since reflection R1 and reflection R2 are now about one-hundred-and-eighty-degrees out of phase from the other, these reflections R1 and R2 will substantially cancel each other out, thereby reducing the amount of reflected ambient light A that is seen by viewer 28.

(It will now be appreciated by those of skiff in the art that a first portion of reflection R2 will be reflected off of the surface of layer 36 and a second portion of reflection R2 will be similarly absorbed by layer 36 as reflection R2 travels from rear electrode 44 to layer 36, much in the same way as reflection R1 and heat vector H1, and accordingly these factors will be considered when choosing desired materials and thicknesses to construct device 20 that produces a first reflection R1 and a second reflection R2 that are out of phase with the other to produce destructive optical interference. However, for simplification of presenting the Figures attached hereto, these effects have not been shown thereon.)

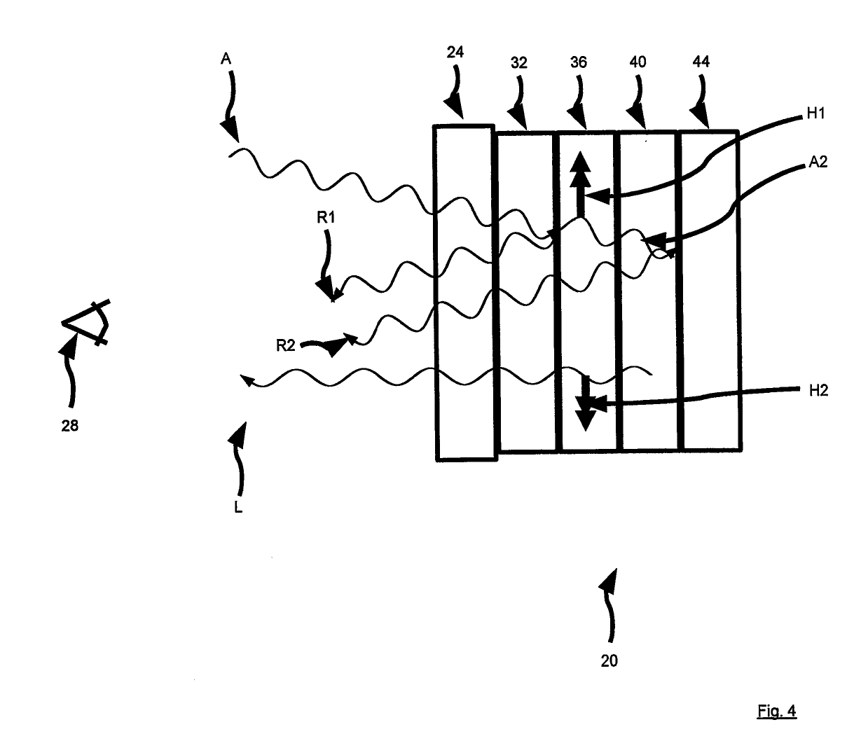

FIG. 4 shows device 20 of FIG. 3, except where device 20 is turned “on” and emitting layer 40 is now emitting light L outwardly therefrom towards viewer 28, As indicated by arrow H2, a small amount of emitted light L is absorbed by layer 36, due to the partially-absorbing nature of layer 36. Simultaneously, however, ambient light A is reduced due to the above-described optical interference characteristics of device 20, wherein reflections R1 and R2 are cancelled out. It will now be apparent to those of skill in the art that the amount of absorption of layer 36 is thus chosen so that, while a certain amount of emitted light L is absorbed as heat H2, the overall contrast of device 20 is improved in relation to a device 20 that did incorporate the destructive optical interference characteristics described above. It will now be further apparent that such choices can depend on the application for device 20—i.e. Where device 20 is intended for use under direct sunlight, then the benefits of device 20 can be more readily utilized than where device 20 is intended for use in a dark room.

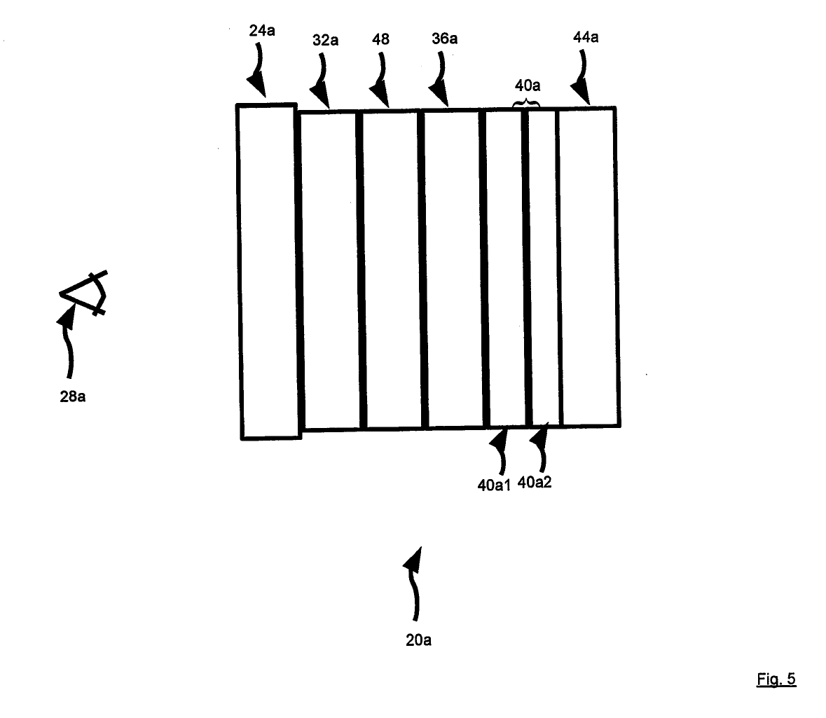

FIG. 5 shows another embodiment of the invention including an organic based electroluminescent device 20a. Like components in device 20a to components in device 20 are given the same reference character, but followed with the letter “a”. It will be understood, however, by persons of skill in the art that while components in device 20a have similar counterparts to components in device 20, that appropriate modifications and variations to those components may be effected to provide desired performance and operation of device 20a.

Referring now to device 20a in FIG. 5, device 20a includes a transparent substrate 24a which faces a viewer 28a in front of device 20a. Behind substrate 24a is a transparent electrode 32a, followed by a hole blocking layer 48, an organic hole transport layer 52, a partially-absorbing layer 36a, an emitting layer 40a, which in turn is composed of an organic light emitting layer 40a1 and an (non-light emissive) electron transport layer 40a2. A reflective rear electrode 44a is mounted behind emitting layer 40a.

In the present embodiment shown in FIG. 5, transparent electrode 32a is an anode, while rear electrode 44a is a cathode, and device 20a is current-driven. Furthermore, partially-absorbing layer 36a is made from a material that provides the desired optical characteristics discussed with reference to device 20 above, but is also work-function matched to emitting layer 40a to provide appropriate electrical operating characteristics of device 20a.

Table 1 shows a list of materials and ranges thicknesses for each of the layers shown in device 20a.

TABLE 1

| | Layer | | Layer | Layer |
|---|---|---|---|---|
| | Character | | Thickness | Thickness |
| | Reference | Layer | (Lower) | (Upper) |
| Layer Name | in FIG. 5 | Material | Angstroms | Angstroms |
| Substrate | 24a | Glass | N/A | N/A |
| Transparent Electrode | 32a | ITO | 800 | 3000 |
| (Anode) | | | | |
| Hole Blocking Layer | 48 | CuPC | 0 | 1000 |
| Hole Transport Layer | 52 | TPD | 0 | 1000 |
| Partially-absorbing | 36a | AlSiO | 100 | 2000 |
| Layer | | | | |
| Organic light | 40a1 | Alq3 | 300 | 1000 |
| emitting layer | | | | |
| Electron Transport | 40a2 | Alq3 | 0 | 1000 |
| Layer | | | | |
| Rear electrode | 44a | Al | 800 | 4000 |
| (Cathode) | | | | |

Table 2 shows a list of materials and even more presently preferred ranges thicknesses for each of the layers shown in device 20a.

TABLE 2

| | Layer | | Layer | Layer |
|---|---|---|---|---|
| | Character | | Thickness | Thickness |
| | Reference | Layer | (Lower) | (Upper) |
| Layer Name | in FIG. 5 | Material | Angstroms | Angstroms |
| Substrate | 24a | Glass | N/A | N/A |
| Transparent Electrode | 32a | ITO | 800 | 1600 |
| (Anode) | | | | |
| Hole Blocking Layer | 48 | CuPC | 100 | 500 |
| Hole Transport Layer | 52 | TPD | 100 | 500 |
| Partially-absorbing | 36a | AlSiO | 200 | 1400 |
| Layer | | | | |
| Organic light | 40a1 | Alq3 | 400 | 800 |
| emitting layer | | | | |
| Electron Transport | 40a2 | Alq3 | 0 | 800 |
| Layer | | | | |
| Rear electrode | 44a | Al | 900 | 1400 |
| (Cathode) | | | | |

Table 3 shows a list of presently preferred materials and thicknesses for each of the layers shown in device 20a.

TABLE 3

| | Layer | | |
|---|---|---|---|
| | Character | | |
| | Reference | | Layer Thickness |
| Layer Name | in FIG. 5 | Layer Material | Angstroms |
| Substrate | 24a | Glass | N/A |
| Transparent | 32a | ITO | 1200 |
| Electrode (Anode) | | | |
| Hole Blocking Layer | 48 | CuPC | 250 |
| Hole Transport Layer | 52 | TPD | 400 |
| Partially-absorbing | 36a | AlSiO | 500 |
| Layer | | | |
| Organic light | 40a1 | Alq3 | 600 |
| emitting layer | | | |
| Electron Transport | 40a2 | Alq3 | 100 |
| Layer | | | |
| Rear electrode | 44a | Al | 1000 |
| (Cathode) | | | |

The thicknesses and materials shown in Table 3 are particularly presently preferred because the thickness of electron transport layer 40a2 is chosen to cause backwardly emitted light from organic light emitting layer 40a1 to be reflected off of rear electrode 44a in such a way as to result in a reflection that is in-phase with the light that is emitted from organic light emitting layer 40a1 forwardly towards viewer 28a, such that the reflected light organic light emitting layer 40a1 and emitted light of organic light emitting layer 40a1 constructively interfere to increase the overall emitted light from layer 40a, and thereby overcome some of the losses of emitted light due to the partial absorption thereof caused by partially-absorbing layer 36a. It will now be understood by those of skill in the art that device 20a (and indeed device 20) can be modified to have different materials and thicknesses such that ambient light undergoes destructive interference while emitted light undergoes constructive interference, to thereby increase the overall contrast experienced by viewer 28a.

It is also to be understood that device 20a can be modified to include thin LiF or LiO layers, for example, on either side of partially-absorbing layer 36a, in order to further enhance the electrical operation of device 20a. Preferably, such thin LiF or LiO layers are deposited so that they do not dissociate into their surrounding layers.

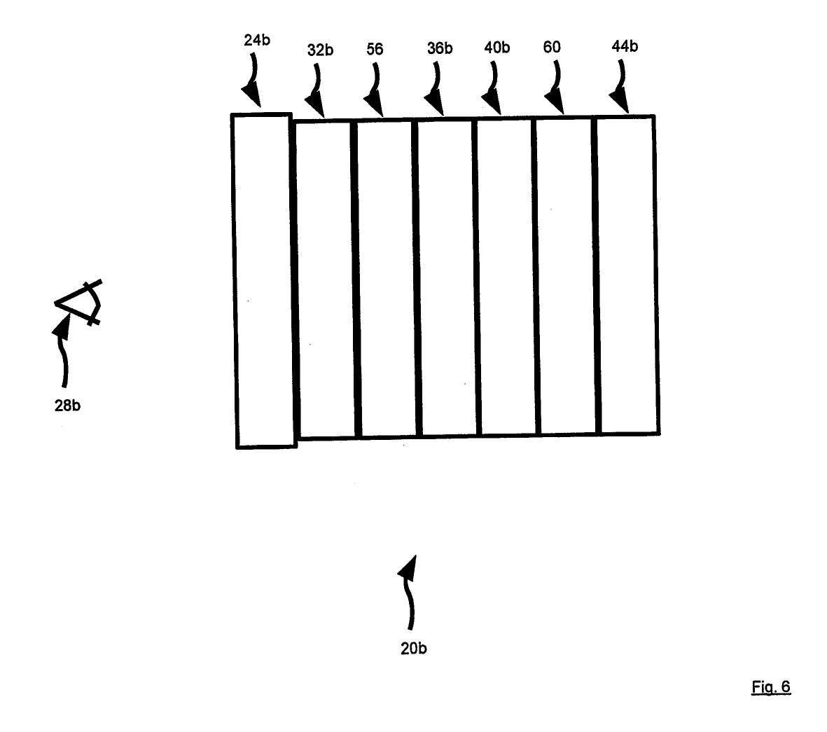

FIG. 6 shows another embodiment of the invention including an inorganic based electroluminescent device 20b. Like components in device 20b to components in device 20 are given the same reference character, but followed with the letter “b”. It will be understood, however, by persons of skill in the art that while components in device 20b have similar counterparts to components in device 20, that appropriate modifications and variations to those components may be effected to provide desired performance and operation of device 20b.

Referring now to device 20b in FIG. 5, device 20b includes a transparent substrate 24b which faces a viewer 28b in front of device 20b. Behind substrate 24b is a transparent electrode 32b, followed by a first dielectric layer 56, a partially-absorbing layer 36b, an emitting layer 40b, a second dielectric layer 60, and a reflective rear electrode 44b. In the present embodiment shown in FIG. 6 device 20b is driven by an AC voltage.

Table 4 shows a list of materials and ranges thicknesses for each of the layers shown in device 20a.

TABLE 4

| | Layer | | Layer | Layer |
|---|---|---|---|---|
| | Character | | Thickness | Thickness |
| | Reference | Layer | (Lower) | (Upper) |
| Layer Name | in FIG. 6 | Material | Angstroms | Angstroms |
| Substrate | 24b | Glass | N/A | N/A |
| Transparent Electrode | 32b | ITO | 1000 | 2400 |
| First Dielectric | 56 | ATO | 800 | 10000 |
| Partially-absorbing | 36b | CrSiO | 100 | 2000 |
| Layer | | | | |
| Inorganic light | 40b | ZnS | 1000 | 8000 |
| emitting | | | | |
| Second Dielectric | 60 | ATO | 800 | 2000 |
| Rear electrode | 44b | Al | 800 | 4000 |

Table 5 shows a list of materials and even more presently preferred ranges thicknesses for each of the layers shown in device 20b.

TABLE 5

| | Layer | | Layer | Layer |
|---|---|---|---|---|
| | Character | | Thickness | Thickness |
| | Reference | Layer | (Lower) | (Upper) |
| Layer Name | in FIG. 6 | Material | Angstroms | Angstroms |
| Substrate | 24b | Glass | | |
| Transparent Electrode | 32b | ITO | 1000 | 1800 |
| First Dielectric | 56 | ATO | 2000 | 8000 |
| Partially-absorbing | 36b | CrSiO | 250 | 600 |
| Layer | | | | |
| Inorganic light | 40b | ZnS | 4500 | 6500 |
| emitting | | | | |
| Second Dielectric | 60 | ATO | 350 | 1200 |
| Rear electrode | 44a | Aluminum | 1000 | 3000 |

Table 6 shows a list of presently preferred materials and thicknesses for each of the layers shown in device 20b.

TABLE 6

| | Layer | | Layer | Layer |
|---|---|---|---|---|
| | Character | | Thickness | Thickness |
| | Reference | Layer | (Lower) | (Upper) |
| Layer Name | in FIG. 6 | Material | Angstroms | Angstroms |
| Substrate | 24b | Glass | | |
| Transparent Electrode | 32b | ITO | 1000 | 1400 |
| First Dielectric | 56 | ATO | 5000 | 7000 |
| Partially-absorbing | 36b | CrSiO | 300 | 550 |
| Layer | | | | |
| Inorganic light | 40b | ZnS | 5000 | 5500 |
| emitting | | | | |
| Second Dielectric | 60 | ATO | 600 | 1000 |
| Rear electrode | 44a | Aluminum | 1000 | 2000 |

While only specific combinations of the various features and components of the present invention have been discussed herein, it will be apparent to those of skill in the art that desired subsets of the disclosed features and components and/or alternative combinations of these features and components can be utilized, as desired. For example, the second dielectric layer 60 of device 20b can be selected to cause reflections that result in constructive interference of the light that is forwardly emitted from inorganic light emitting layer towards viewer 28b.

Furthermore, it is to be understood that the layers described above can be put in different orders, and certain situations, eliminated. For example, Electron Transport Layer 40a2 discussed above can be eliminated altogether in certain embodiments. Furthermore, partially-absorbing layer 36a and partially-absorbing layer 36b can come earlier in the stack of need not be adjacent its respective emitting layers 40a and 40b, and could be placed earlier in the stack closer to substrate 24a and 24b. In such case the layers behind partially-absorbing layer 36a are preferably chosen to have a combined thickness to provide the desired phase-inversion to achieve at least some destructive optical interference to reduce unwanted ambient light.

It is to be further understood that partially-absorbing layer 36a and 36b can itself be composed of several sub-layers. Similarly, rear electrode 40 can also be a stack of several sub-layers.

It will be understood that the teachings herein can be modified for use in active matrix and/or passive matrix displays. Further, the embodiments herein can be modified for use in multi-coloured displays, by appropriately modifying the layers of within device 20, 20a, 20b or variations thereof to provide desired levels of destructive optical interference of ambient light and desired levels of constructive optical interference of emitted light.

The present invention provides a novel electroluminescent device that incorporates a partially-absorbing layer which causes a first reflection of a portion of ambient light, and an emitting layer behind the partially-absorbing layer that has a thickness which causes the remainder of ambient light that passes through the partially-absorbing layer to be reflected off a reflective rear electrode so that the second reflection is about one-hundred-and-eighty-degrees out of phase with the first reflection, thereby causing destructive optical interference and reducing ambient light.

1. An electroluminescent device comprising a transparent substrate for facing a viewer in front of said substrate; a transparent electrode disposed behind said substrate on a side of said substrate opposite from said viewer; a partially-absorbing layer disposed behind said electrode; an electroluminescent emitting layer disposed behind said partially-absorbing layer; a reflective rear electrode disposed behind said emitting layer, said emitting layer being made from a material operable to emit light towards when a potential is applied between said electrodes; said partially-absorbing layer and said emitting layer each being made from a material and having a thickness that are chosen to cooperate with said reflective rear electrode such that at least a portion of ambient light incident on said device is reduced.

2. The device according to claim 1 wherein said transparent front electrode is made from ITO.

3. The device according to claim 1 wherein said rear electrode is made from Aluminum.

4. The device according to claim 1 wherein said electroluminescent layer is made from a material selected from the group consisting of ZnS: Mn, Alq3, PPV.

5. The device according to claim 1 wherein said partially-absorbing material is made from a metal oxide selected from the group consisting of AMO, SiO, InO, SnO, ZnO.

6. The device according to claim 1 wherein said partially-absorbing material is made from a metal:metal oxide materials selected from the group consisting of Cr:SiO, Al:SiO, In:SnO or Al:ZnO.

7. The device according to claim 1 wherein said emitting layer thickness is also chosen such that, in cooperation with reflections of emitted light off of the rear electrode, at least a portion of emitted light is increased due to constructive optical interference.

8. An electroluminescent device comprising a transparent substrate for facing a viewer in front of said substrate; a transparent anode disposed behind said substrate on a side of said substrate opposite from said viewer; a hole blocking layer disposed behind said transparent electrode; a hole transport layer disposed behind said hole blocking layer; a partially-absorbing layer disposed behind said hole blocking layer; an organic electroluminescent emitting layer disposed behind said partially-absorbing layer; a reflective rear cathode disposed behind said emitting layer, said emitting layer being made from a material operable to emit light towards when a current is applied between said electrodes; said partially-absorbing layer and said emitting layer each being made from a material and having a thickness that are chosen to cooperate with said reflective rear cathode such that at least a portion of ambient light incident on said device is reduced.

9. The device according to claim 8 wherein said anode is made from ITO.

10. The device according to claim 9 wherein said hole transport layer is made from TPD and said hole blocking layer is made from CuPC.

11. The device according to claim 8 wherein said cathode is made from Aluminum.

12. The device according to claim 8 wherein said electroluminescent layer is made from Alq3.

13. The device according to claim 8 wherein said electron transport layer is made from Alq3.

14. The device according to claim 8 wherein said partially absorbing layer is made from AlSiO.

15. The device according to claim 8 wherein said substrate is flexible.

16. An electroluminescent device comprising: a transparent substrate for facing a viewer in front of said substrate; a transparent anode made from ITO and having a thickness of between about 800 Å and about 3000 Å, said anode disposed behind said substrate on a side of said substrate opposite from said viewer; a hole blocking layer made from CuPC and having a thickness of less than about 1000 Å, said hole blocking layer disposed behind said transparent electrode; a hole transport layer made from TPD and having a thickness of less than about 1000 Å, said hold transport layer disposed behind said hole blocking layer; a partially-absorbing layer made from AlSiO and having a thickness of between about 800 Å and about 3000 Å, said partially-absorbing layer being disposed behind said hole blocking layer; an organic electroluminescent emitting layer made from Alq3 and having a thickness of between about 300 Å and about 1000 Å, said electroluminescent emitting layer disposed behind said partially-absorbing layer; a reflective rear cathode made from Al and having a thickness of between about 800 Å and about 4000 Å, said cathode disposed behind said emitting layer, said Alq3 operable to emit light towards when a current is applied between said anode and said cathode and wherein a specific thickness of each of said partially-absorbing layer and said emitting layer are chosen to cooperate with said reflective rear cathode to reduce at least a portion of ambient light incident on said device.

17. The device according to claim 15 wherein said ITO layer has a thickness of from about between about 800 Å and about 1600 Å.

18. The device according to claim 15 wherein said CuPC layer has a thickness of between about 100 Å and about 500 Å.

19. The device according to claim 15 wherein said TPD layer has a thickness of between about 100 Å and about 500 Å.

20. The device according to claim 15 wherein said AlSiO layer has a thickness of between about 200 Å and about 1400 Å.

21. The device according to claim 15 wherein said Alq3 layer has a thickness of between 400 Å and about 800 Å.

22. The device according to claim 15 wherein said rear cathode has a thickness of between about 900 Å and about 1400 Å.

23. The device according to claim 15 further comprising an electron transport layer made from Alq3 between said rear cathode and said emitting layer and having a thickness of less than about 800 Å.
